(19) United States
(12) Patent Application Publication
(10) Pub. No.: US 2005/0075911 A1
(43) Pub. Date: Apr. 7, 2005

(54) Method for producing, selling, and delivering data required by mortgage lenders and servicers to comply with flood insurance monitoring requirements

(75) Inventor: Don A. Craven JR., Austin, TX (US)

Correspondence Address: VINSON & ELKINS, L.L.P., 1001 FANNIN STREET, 2300 FIRST CITY TOWER, HOUSTON, TX, 77002-6760, US

(73) Assignee: Affiliated Flood Group, L.L.C.

(21) Appl. No.: 10/679,707

(22) Filed: Oct. 3, 2003

(51) Int. Cl. G06F 17/60

(52) U.S. Cl. 705/4

(57) ABSTRACT

A system and method for compliance with flood insurance monitoring requirements comprises a central computer system containing a database of essentially all properties affected by map changes, including any official action undertaken by or on behalf of FEMA in its administration of the National Flood Insurance Program. The database is provided to remote users, particularly mortgage servicers, on a subscription basis.

### BACKGROUND OF THE INVENTION

In 1973, the Flood Disaster Protection Act was enacted. This Act and the National Flood Insurance Act of 1968, which preceded it, required mortgage lenders to determine the flood risk of a property before making a mortgage loan on that property. The Federal Emergency Management Agency (FEMA) produces official maps, Flood Insurance Rate Maps (FIRM), that identify flood risk zones, and that are used for the purpose of determining the need for flood insurance. The National Flood Insurance Reform Act of 1994 made mortgage loan servicers (“Servicers”) responsible for keeping up with flood map changes affecting the properties in their loan portfolio for the entire life of the loan. This is referred to as “life of loan tracking” or “monitoring” in the industry.

Since the FEMA maps are technical and not “user friendly,” as a matter of practice, mortgage Servicers contract with independent flood zone determination companies (FZDCs) to interpret the maps and manage this process on their behalf for a fee. Because this service is currently performed on a per-loan basis (i.e. “life of loan”) the FZDC only delivers data for each Servicer's specific loans as needed. The Servicer is required to submit its portfolio of addresses to the FZDC so that the FZDC can monitor them for flood zone changes. The FZDC gets the FEMA map updates and official Letters of Map Change (LOMCs) as they are officially produced by FEMA on a periodic basis, determines if/which properties of the lender are affected by the any changes, and notifies the Servicer in the event that any of a particular Servicer's properties are affected (who then notifies the borrower).

The FZDC's effectively serve as the intermediary between FEMA and the mortgage Servicers by interpreting the maps and map revisions and notifying each of the loan Servicer clients when any of its mortgaged properties are located in areas affected by the map changes. The FZDC's only determine and notify the Servicer of the affected loans that are in its particular portfolio based on the latest information received from the Servicers of their mortgage loan portfolio. It is believed that no current flood zone determination companies produce a comprehensive ‘master list’ of each and every address that are affected by the map changes. An inherent weakness and inefficiency in this system is that in order for the system to work, the FZDC must have a current and updated copy of the loan portfolio of each Servicer who is their client.

To ensure that the FZDC has current loan data from the Servicer, the Servicers must continuously provide the FZDC with any and all additions to (new loans, purchased loans, etc), and deletions from (pay-offs, sold loans, etc) its loan portfolio. Additionally, in the event of a sale of a loan to another Servicer, the seller of the loan typically must notify the vendor of the new Servicer, and provide relevant contact information. It is a cumbersome, inefficient, expensive, and often neglected process that must be borne by the Servicer. It is such an inefficient system, it is estimated that fully one third of FZDC notification letters are sent to the wrong Servicer. This leads to a high level of non-compliance and an assumption of financial risk on the part of the Servicer.

The current system is also inefficient for discouraging competitive pricing and access to the market for new and smaller FZDC's who offer more competitive pricing. In the mortgage industry, the originator is the initial mortgage lender who, in most cases, actually works with the borrower to initiate the loan. The loans are then typically sold or transferred to a larger mortgage company (the Servicers) who then collect the payments and service the loans. These large mortgage companies include some of the largest banks and financial institutions in the world. Because the Servicers are able to force higher margin business from smaller lenders, they are able to contract with their preferred FZDC for very favorable rates.

The loan originators are required to include flood insurance in the mortgage closing for those properties that are in a Special Flood Hazard Area (SFHA) as determined by FEMA. The originator may choose any FZDC to identify whether or not a given property is in a SFHA (therefore requiring flood insurance), but when the loan is sold or transferred to a Servicer, if the Servicer uses a different FZDC than the originator used, then the originator is typically required to pay a conversion fee. In practice, in order to avoid this fee, originators typically contract with the FZDC's that are favored by the major Servicers who are most likely to ultimately service the orginator's loans. This discourages mortgage loan originators from using new or smaller FZDC's, even if the price and service are superior, because they can avoid paying the conversion fee by using the Servicer's preferred FZDC. This monopolistic system keeps flood certification rates artificially high, but this is largely unnoticed by the consumer because flood certification is such a small part of the loan settlement costs for individual mortgages. There is a need, therefore, for a more competitive and efficient system of providing life of loan flood zone monitoring services for mortgage lenders in their efforts to comply with applicable regulations.

Additionally, the method by which these monitoring services are paid for and delivered contributes to monopolistic and anti-competitive pricing. For example, the FZDC's have imposed a “pay first” standard on their lender-Servicer clients. The entire “life of loan” monitoring fee is typically collected at loan origination on a fee-per-loan basis, keeping the Servicer in a perpetual state of “service debt.” Put another way, the loan Servicer is permanently put in a state of having future tracking services owed to it, for which it has already paid in full. Since these fees are typically non-refundable, a Servicer would be required to effectively double pay to switch vendors to obtain tracking for its pre-paid portfolio. This practice provides an enormous disincentive to switch, further thwarts competition and keeps prices artificially high.

### SUMMARY

In preferred embodiments, practice of the invention would include continuously collecting all official data from FEMA pertaining to map revisions. As used herein “map revisions” refers to physical map revisions, Letters of Map Change (LOMC) (including Conditional Letters of Map Amendment (CLOMA) and Conditional Letters of Map Revision (CLOMR)), Letters of Map Amendment (LOMA), Letters of Map Revision (LOMR), changes in Community Participation Status in the National Flood Insurance Program, and any other official data pertaining to revisions to National Flood Insurance Program (NFIP) or Flood Insurance Rates Maps (FIRM) that is released by FEMA, the NFIP, or any other authorized agency or entity. The phrase “map revision” then refers to any official event under the NFIP that has consequences on a lender's obligation to comply with life of loan flood insurance rules. The data is then compiled and collected into a centralized and comprehensive processing system that includes all available map revision data having official implications on the life of loan monitoring obligations placed on lending institutions under the National Flood Insurance Reform Act and other applicable regulations. Specialized standardization of the map revision data is utilized for accuracy and processing efficiency, with particular emphasis on the following map revision data attributes: Community Number, Community Participation Status, FIRM Panel Number, FIRM Panel Suffix, FIRM Effective Date, Flood Zone, Special Flood Hazard Areas (SFHA) information, and properties or areas affected by map revision data. The affected properties are identified by property identification information, including property address(es) or other means used to identify individual properties as discussed in more detail below.

Community number may be understood from the following description: In 1968, Congress created the National Flood Insurance Program (NFIP) in response to the rising cost of taxpayer funded disaster relief for flood victims and the increasing amount of damage caused by floods. The Mitigation Division, a component of the Federal Emergency Management Agency (FEMA) manages the NFIP and oversees the floodplain management and mapping components of the Program. Nearly 20,000 communities across the United States and its territories participate in the NFIP by adopting and enforcing floodplain management ordinances to reduce future flood damage. In exchange, the NFIP makes federally backed flood insurance available to homeowners, renters, and business owners in these communities. Under the NFIP, “community” is defined as “any State, or area or political subdivision thereof, or any Indian tribe or authorized tribal organization, or Alaska Native village or authorized native organization, which has authority to adopt and enforce floodplain management regulations for the areas within its jurisdiction”.

Community Participation Status is subject to change. The NFIP produces a Community Status Book (CSB), which lists all communities participating in the National Flood Insurance Program or for which flood maps are effective. The Community Status Book includes status of communities, non-participating communities with maps, effective dates of the current map index, and community numbers. The data attributes associated with Communities in the Community Status Book are: Community Number, Community Name, Date of Community's Entry into the NFIP (either the “Regular” or “Emergency” program), and Effective Date of the currently effective flood map of the community. All such community data may be included in the central computer database provided as described herein.

Practice of preferred embodiments may further include identifying, through a combination of manual and automated methodologies, essentially all properties that are impacted by the map revision data, and producing and making available a continuously updated list of essentially all properties (in the form of a comprehensive list in a standard format that is easily accessible, such as postal addresses) that are impacted by the map revision data. Primarily, properties are affected in one of two ways, either (i) as a result of the map revision data, a property that was previously located within a Special Flood Hazard Area (SFHA) is no longer within the SFHA, and therefore flood insurance is no longer required; or (ii) as a result of the map revision data, a property that was previously not located within a SFHA is now located within a SFHA, and therefore flood insurance is now required. The list of impacted property identification information is then stored in a proprietary web-enabled database that is accessible to remote users that have been provided with passwords or other means of user authentication, so that the remote users can automatically compare their portfolio of mortgage loans (preferably by property address) against the master list of property addresses impacted by map revision data. The web-enabled database is preferably interfaced with, through standard data interface methodologies used by lending institutions, including but not limited to the “MISMO” standard endorsed by the Mortgage Bankers Association of America. As used herein property address is interchangeable with the term property identification information and is further defined below.

In certain preferred embodiments the invention may be described as a computer-based system for compliance with flood insurance monitoring requirements. Flood insurance monitoring requirements are known in the art and are imposed by the federal government to require mortgage servicers to be responsible for keeping up with flood map changes affecting the properties in their loan portfolios for the entire life of the loans. These requirements may change over time, and the databases created in the practice of the invention would also be changed to meet those requirements. Any such changes are contemplated by the present invention.

The computer based system of the invention preferably includes a central computer system that includes a storage media for storing at least one database that includes a list of essentially all properties within a selected geographical region that are affected by changes in Flood Insurance Rate Maps, Letters of Map Change or changes in Community Participation Status. The storage media can be any means known in the art, preferably any digital means, including but not limited to digital tapes or discs. The database storage means is preferably contained in a database server. The system further includes a means for storing computer applications software that is connected to the database storage media or database server. The computer applications software is preferably contained in an applications server that is connected to a database server.

The application server is the intermediary between the remote user and the raw data contained in the database server. The main functions of the application server are user authentication, account verification, access restrictions and administration.

User Authentication: As a backup to the firewall, the application server further identifies the remote user, and logs information about the user session (such as the date & time they logged in, the remote system IP Address, the duration of each user session, and other user-specific data pertaining to each user session).

Account Verification: The application server checks to see if the remote user is currently authorized to use the system. For example, the application server checks to make sure that the current user session being requested is within the time-based subscription period that the client has paid for.

Access Restrictions: In certain embodiments, clients may have certain negotiated restrictions on what they are allowed to access. For example, one client may only desire a list of affected addresses in a single state; and may request to pay a discounted rate for the service. In that case, the application server would execute whatever access restrictions apply to each account (the database server would represent “everything”, and the application server would control access to it).

Administration: Authorized users are able to log on to a web-based application on the application server to access certain account information and administrative reports. For example, an authorized user provides their account username and password and views information such as how many days remain on their current subscription, a log of their access and use history, and information about the data that has been downloaded to their system from the central computer system.

The system further includes a modem connected to the applications means and effective to connect the central computer system to a plurality of remote computers. Any type of modem known in the art is acceptable, and may be a modem for connecting the central computer system to a plurality of remote computer stations through a web based communication network, a telephonic or cable communication system, or through a wireless communication system, for example. The system preferably further includes an electronic firewall for restricting access to the database to authorized users. Authorized users are those with a paid subscription on a time basis. The database is thus available to subscribers for the life of the subscription and availability is not tied to the life of any particular mortgage loan.

In a most preferred embodiment, the database contains a list of essentially all properties within any geographical area under the authority of the laws of the U.S. Congress, including all states of the United States of America, its territories and protectorates. In practice, then one creates a list of essentially all properties within that area that are affected by the described map changes. In certain embodiments, however, a subscriber may need less than the entire database, and therefore, the database may contain properties within a selected geographical region such as the United States of America or even a particular state within the United States of America, or any other political or geographical subdivision thereof. In the preferred embodiments of the invention, a practitioner makes a good faith effort to identify every property within a given geographical or political area that is affected by any map changes and all of those properties are listed in the database. It is possible, however, that in translation of the raw data into property addresses or property identification information, some properties may not be listed. As such, in the present disclosure, the term “essentially all” is defined to mean at least 95% of the affected properties or preferably at least 98% or even more preferably 99-100% of the affected properties.

In certain preferred embodiments, the affected properties in the database are listed by property identification information, or property address. “Property identification information, or property address” as used herein is understood to mean any type of address that identifies the particular property that is in the list. There are various ways in which local governments organize property records and are thus various ways to identify a particular property. In addition to postal and delivery addresses, a property may be identified by block, block face, intersection, parcel, building, building complexes, entrance, unit, or even landmark name, for example. As used herein, property identification information or property address may mean any means of referring to the identification or location of a distinct unit of real estate, including all of the means listed in the table below. For purpose of illustration only, the most common form of property address includes a street address (such as “101 Main St”), a city (such as “Houston”), a State (such as “TX” or “Texas”), and a ZIP Code of either 5 digits (such as “77079”) or 9 digits when the ZIP+4 extension is included (such as “77024-1743”). Examples of types of property identification information or property addresses have been identified by the Property Records Industry Association. A list of property types and a brief description of each follows:

| | |
|---|---|
| Property Street Address | The unstructured (Unparsed) street address |
| | of the subject property (e.g., 123 Main |
| | Street). |
| Property Street Address 2 | Unit Number (if any) of the property |
| | described in the document |
| Property City | The city in which the subject property is |
| | located. |
| Property State | The state in which the subject property is |
| | located. |
| Property Postal Code | The postal code (zip code in the US) of the |
| | subject property. Zip code may be either 5 |
| | or 9 digits. |
| Property County | The county in which the subject property is |
| | located. |
| Property Assessors Parcel Identifier | The parcel number assigned to the subject |
| | property by the Assessor |
| Property Identification County FIPS Code | The County FIPS Code of the subject |
| | property |
| Property Identification State FIPS Code | The State FIPS Code of the subject |
| | property |
| Property Legal Description | Subject property legal description |
| | information. |
| Parsed Street Address Street Name | Parsed Street Address Name |
| Parsed Street Address Direction Prefix | Parsed Street Address Direction Prefix |
| Parsed Street Address Direction Suffix | Parsed Street Address Direction Suffix |
| Parsed Street Address Street Suffix | Parsed Street Address Street Suffix |
| Parsed Street Address Street Type | Parsed Street Address Type |
| Parsed Street Address House Number | Parsed Street Address House Number |
| Parsed Street Address Apartment or Unit | Parsed Street Address Apartment or Unit |
| | number |
| Parsed Street Address Rural Route | Parsed Street Address Rural Route |
| Property Legal Description Parcel | Parcel Identification Identifier |
| Identification | |
| Property Legal Description Parcel | Type of Parcel Identification assigned by a |
| Identification Type Identifier | government entity, other than Assessor's |
| | Parcel Number. These are sometimes |
| | required to be noted on a document to |
| | entitle the document to be recorded by a |
| | County Recorder. |
| Property Legal Description Parcel | Identification number associated with the |
| Identification Number Identifier | type of Parcel Identification e.g. Tax Parcel |
| | Number, Torrens Certificate Number |
| Property Legal Description Parcel | Actual text description of Parcel |
| Identification Description | Identification |
| Platted Land Plat Code Value | A coded identification number assigned to |
| | a plat by a county to be used to identify a |
| | plat in place of a subdivision name or |
| | platbook and page. |
| Platted Land Plat Book Identifier | Number assigned to Plat on file with |
| | County |
| Platted Land Plat Page Identifier | Plat Page Number |
| Platted Land Plat Instrument Number | Plat Instrument Number |
| Property Lot Identifier | Lot unit as shown on Plat on file with |
| | County |
| Property Block Identifier | Block unit as shown on Plat on file with |
| | County |
| Property Section Identifier | A portion of a subdivision plat generally |
| | larger than a block, and which may contain |
| | lots, blocks or lots and blocks. |
| Property Subdivision Identifier | Subdivision name of a platted subdivision, |
| | condominium or timeshare condominium |
| Property Tract Identifier | Tract Number designated on a |
| | Condominium or Timeshare Condominium |
| | survey |
| Platted Land Building Number Identifier | Building identifier of a building in a |
| | condominium or timeshare condominium |
| Platted Land Unit Number Identifier | Unit Identifier of a building in a |
| | condominium or timeshare condominium |
| Unplatted Land | Legal Description for lands not covered by |
| | recorded or filed plats |
| Unplatted Land Type | The type of land description system used |
| | for unplatted lands, either Government |
| | Survey or metes and bounds (land) without |
| | a formal system, e.g. land grants. |
| Unplatted Land Base Number | The Government Survey Base coordinate |
| | of the property is the east-west line from |
| | which to measure Township lines north or |
| | south of the base line. |
| Unplatted Land Meridian Number | The Government survey Meridian of the |
| | property is the north-south line from which |
| | to measure Range lines east and west of the |
| | Meridian, or starting point. |
| Unplatted Land Township Identifier | The Government Survey Township |
| | coordinate and direction code of Property, |
| | e.g. 37N |
| Unplatted Land Range Identifier | The Government Survey Range coordinate |
| | and direction code of the property, e.g. 12E |
| Unplatted Land Section Identifier | The Government Survey section in which |
| | the property is located, numbered 1 through |
| | 36 though some jurisdictions have up to |
| | 100 sections. |
| Unplatted Land Quarter Section Identifier | The quarter sections in which the property |
| | is located. Based on Government Survey |
| | system. Up to four quarter or half sections |
| | may be used to describe or locate the |
| | property, e.g. NE SE SW NW or W2 NW. |
| Unplatted Land Metes & Bounds | The text of the remaining portion of a |
| Remaining Text | Metes and Bounds description after |
| | indexing information is populated into |
| | other index tags. |
| Unplatted Land Land Grant Identifier | Identifier of Land Grants issued by foreign |
| | governments to then citizens of the country |
| | during that country's ownership or control |
| | of a territory now part of the United States, |
| | e.g. Gomez Grant |
| Unplatted Land Abstract Number Identifier | An Identifier of an irregular parcel of land |
| | called an Abstract. |
| Property Legal Description Other Legal | A method of describing a parcel that cannot |
| | be described as Platted Land or Unplatted |
| | Land. |
| Property Legal Description Other Legal | Unique reference to a kind of description |
| Type | e.g. named township, native american |
| | sovereign lands, or rancheros |
| Property Legal Description Other Legal | Actual text description of Other Legal |
| Description | lands |
| Property Legal Description Other Legal | Name of the Other Type Description used |
| Type Other Description | for the Legal Description |
| Latitude/Longitude Coordinates | Expressed either in |
| | degrees/minutes/seconds or in decimal |
| | form, the latitude and longitude coordinates |
| | that describe the location of a distinct unit |
| | of real estate. |

Any of such property identification information identifiers, or any combination of such identifiers may be used as property addresses in the practice of the inventions disclosed and claimed herein. In addition, any other type of property identifiers known in the art or to be developed are contemplated by the present invention. For example, certain federal agencies such as the Federal Geographic Data Committee may propose or adopt address data content standards for all properties within the federal jurisdiction. Such standards may include property descriptions including, but not limited to a unique address ID that may be assigned for each address, an address type (parcel, building, etc., address locator (either by geographical coordinates or other means), address domain (may include potential addresses of undeveloped land, etc.), and address status (addresses may be in use, proposed, retired, changed, etc.). The incorporation of any federal standard address system into the practice of the present invention is contemplated by this disclosure. In certain preferred embodiments, and where appropriate, the property addresses are standardized postal addresses.

As used herein, changes in Flood Insurance Rate Maps, Letters of Map Change, or more generally map changes would include any official action undertaken by or on behalf of FEMA in its administration of the National Flood Insurance Program that has the effect of revising or modifying information contained on Flood Insurance Rate Maps or Flood Hazard Boundary Maps, including physical map revisions, letters of map change, and changes to community participation status, to the extent that such revision or modification has regulatory compliance implications for lending institutions. Such changes would include, but are not limited to changes contained in Federal Emergency Management Agency (FEMA) map updates, official Letters of Map Change (LOMCs), Letters of Map Amendment (LOMA), Letters of Map Revision (LOMR), Conditional Letters of Map Amendment (CLOMA), Conditional Letters of Map Revision (CLOMR), or combinations of any thereof.

The present inventions may also be described in certain preferred embodiments as a computer-implemented method of providing a flood hazard zone determination for selected users on a subscription basis. The method includes obtaining map revision data having relevance to life of loan flood insurance regulations; inputting the data into a central processing system; processing the data to produce a database including essentially all properties affected by the revised maps in which the properties are identified by property identification information; storing the database in an electronic storage means; and providing an electronic interface to a communication system accessible by one or more remote computers, wherein access is provided on a time-based, subscription service for the time period in which the data is supplied. The method is thus further distinguished from the prior art methods discussed above in which “life of loan” coverage is provided on an up-front/per loan basis. Rather, the present invention provides a subscription in which the user has access to the database for the life of the subscription, and the subscription covers essentially all properties and not just the collateral property for a particular mortgage, or even the portfolio of a particular Servicer.

The databases of the present inventions, then contain lists of properties that are preferably not proactively filtered to contain only properties that a particular client would be concerned about. In the prior art, FZDC's may provide lists of properties affected by map revisions to their clients, but those lists are filtered for each individual client.

The present inventions may also be described in certain embodiments as a method of providing a mortgage loan Servicer with Flood Insurance Rate Map (FIRM) information for properties affected by flood map revisions. The method includes obtaining map revision data relevant to Flood Insurance Rate Maps; compiling a database of essentially all properties in which the properties are affected by the revisions, wherein the affected properties are described by property identification information; and providing selected mortgage Servicers electronic access to the database. In the practice of the method the map revision data may be contained in Federal Emergency Management Agency (FEMA) map updates, official Letters of Map Change (LOMCs), Letters of Map Amendment (LOMA), Letters of Map Revision (LOMR), Conditional Letters of Map Amendment (CLOMA), Conditional Letters of Map Revision (CLOMR), or combinations of any thereof.

It is also an aspect of the method of the inventions that the property attributes listed in the database may include Community Number, FIRM Panel Number, FIRM Panel Suffix, FIRM Effective Date, Special Flood Hazard Areas (SFHA) information, and properties or areas effected by map revision data identified by property identification information. Furthermore, the database may contain property identification information including a listing of affected properties identified by address, city, state, zip code, old zone, new zone, panel, date of revision and community, and additional information including, but not limited to a listing of affected geographical areas identified by community, panel, old suffix, new suffix, and effective date of revision. In the practice of the methods, access to the database is provided on a subscription basis for a time period covered by the subscription.

In certain embodiments, the inventions may be described as a method for providing updated Flood Insurance Rate Map information comprising: obtaining all map revision data relevant to Flood Insurance Rate Maps for the United States of America, and its Territories and Protectorates, wherein the map revision data is obtained from one or more of Federal Emergency Management Agency (FEMA) map updates, official Letters of Map Change (LOMCs), Letters of Map Amendment (LOMA), Letters of Map Revision (LOMR), Conditional Letters of Map Amendment (CLOMA), or Conditional Letters of Map Revision (CLOMR); compiling a master list of essentially all properties within the United States of America, its Territories and Protectorates that are affected by the revisions wherein the affected properties are identified by property identification information, comprising address, city, state, zip code, old zone, new zone, panel, date of revision and community, and further wherein property attributes are listed, comprising Community Number, FIRM Panel Number, FIRM Panel Suffix, FIRM Effective Date, and Special Flood Hazard Areas (SFHA) information; storing the master list in a computer system in which the computer system is connectable to remote computers through a firewall that allows only approved users to connect to the computer; and providing selected remote computer users electronic access to the master list on a subscription basis. The method may comprise compiling a second master list of map revision data comprising a listing of affected geographical areas identified by community, panel, old suffix, new suffix, and effective date of revision, wherein the second master list is stored on the computer system and is accessible by the approved remote users.

Throughout this disclosure, unless the context dictates otherwise, the word “comprise” or variations such as “comprises” or “comprising,” is understood to mean “includes, but is not limited to” such that other elements that are not explicitly mentioned may also be included. Further, unless the context dictates otherwise, use of the term “a” may mean a singular object or element, or it may mean a plurality, or one or more of such objects or elements.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic drawing of a preferred embodiment of a computer system of the present invention.

### DETAILED DESCRIPTION

Certain aspects of the present disclosure are based on the creation of a national, comprehensive, continually updated compendium of properties affected by flood map changes, access to which is available by subscription directly to mortgage Servicers. The Servicer would simply periodically access a listing of properties and query its loan portfolio to see if any are on “the list” of properties affected by a map change. The need for the constant exchange of portfolio data currently required of the Servicer in order to comply with Federal regulations is thus eliminated, and replaced with a less expensive and more efficient means of compliance. Additionally, the present disclosure decreases the absolute dependence on a third party FZDC, putting the Servicer in a position to essentially do its own “life-of-loan” tracking, and to enjoy an economic opportunity to profit from the process by charging the originator a fee for the service, should they elect to do so. Furthermore, by divorcing the payment for a “basic” certification fee from the “life of loan” fee, loan originators are no longer directed to buy from the Servicer's FZDC, promoting more competition and fair pricing. Since the fees are preferably based on a time-based subscription and not on an up-front per-loan basis, the notion of “life of loan” dissolves entirely. The Servicers are thus free to switch methods of compliance as needed without a financial penalty for doing so.

In the practice of the inventions, a practitioner first receives map change “raw materials” from FEMA, the NFIP, or any other authorized agency or entity in various forms as identified above or in any form provided now or in the future. Once a given set of raw materials is obtained from FEMA, this information is manipulated to create the database, or master list of affected properties. Unfortunately, the raw materials from FEMA do not include convenient lists of addresses that have been impacted by a map revision and that can easily be interfaced by a Servicer's computer system. Rather, the raw materials typically consist of maps showing revised flood zone locations, and sometimes non-standardized descriptive text about areas that have been impacted by map revisions as in LOMC's, for example. In the practice of the inventions, the raw material is translated into a standardized format that is dramatically more user-friendly. Specifically, a list may be created of essentially all properties that have been impacted by the map revisions in the given set of raw material obtained from FEMA. If the raw material obtained from FEMA makes references to “addresses”, but the “addresses” referenced are incomplete or ambiguous, the addresses are processed (either manually or using automation when warranted) through commercially-available United States Postal Service-certified address standardization software, such as AccuZip. The software is updated at least monthly to account for new addresses or address changes.

To create the list of addresses impacted by flood map revisions, the raw material from FEMA is compared to a high-end, commercially-available digital map base representing all properties in the US. Although some digital map bases describe properties by post office address, such a digital map to be used in the practice of the present inventions may include any or all types of property information as described herein or as known in the art. The map base is continually updated to account for new addresses, address changes, and so forth. It is interactively manipulated by a trained worker, using standardized, documented methods, who queries the street map base by address, zip code, city, county, state, region, or other means. This street map base is also queried and manipulated programmatically, with software that automates the manual interaction of the trained worker. An example of such software is “DynaMap” from Geographic Data Technology.

In some cases, the flood map revision data is compared to the street map base manually (such as when the map revision only affects a small quantity of properties, which may not justify the expense and effort associated with automation). In this case, an individual examines the flood map revision data and creates a geographic region on the street map base (through pointing and clicking using GIS software such as Arc/Info from ESRI or MapInfo) that is the virtual equivalent of the revised flood zone area (either revised from “out” to “in” or from “in” to “out”) as described in the raw material obtained from FEMA. Once this geographic region is created, the user queries the street map base to identify all properties within the changed region (either revised from “out” to “in” or from “in” to “out”). These properties are then entered in tabular form, either manually or automatically, to a database table; along with the old and new flood map attributes.

If the flood map change data warrants it, the manual process described above is automated. In this case, the flood map change data is separately digitized (either revised from “out” to “in” or from “in” to “out”) without manually interacting with the street map base; resulting in a stand-alone digitized map coverage consisting of recently-revised flood zone information as described in the raw material obtained from FEMA. The new coverage identifies the geographic extent of the areas that have changed their flood zone (either “in” to “out” or “out” to “in”). Once this unique digitized map coverage is created, GIS software is used to overlay the flood zone coverage map against the street map base. A query is then run to automatically identify the standardized street addresses from the street map base that are physically located within the changed geographic areas. These standardized street addresses are then entered, in tabular form, to a database table; along with the old and new flood map attributes (just as in the manual process described above).

The creation of the tabular data in the database table is the final step in the process of “translating” the raw flood map revision data from FEMA into a list of property identification information for essentially all properties that have been impacted by the map revision.

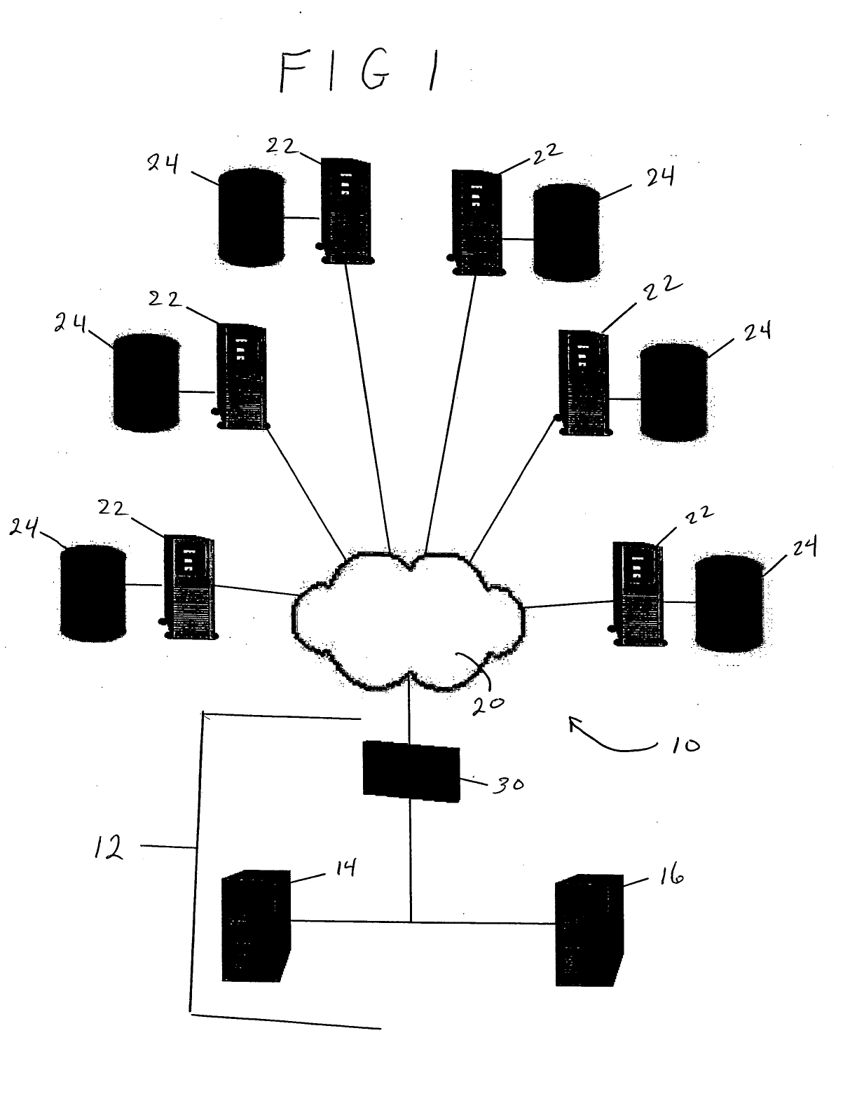

An aspect of the present inventions is a computer-based method of providing Special Flood Hazard Area status for essentially all properties within a selected geographical region that are affected by changes in Flood Insurance Rate Maps. A system for implementing this method is shown in FIG. 1. A preferred system 10 would include a central computer system 12 comprising an application server 14 connected to a database server 16. The central computer system is connected through the internet 20 to a plurality of remote computers 22 through a firewall 30 that restricts access only to authorized users. Each remote computer includes or has access to a database containing the remote users loan servicing portfolio 24. In practice the map revision database is preferably downloaded to each remote computer 22 and compared to the individual loan servicing portfolios 24, thus identifying properties within the portfolios that are affected by map revisions.

In preferred embodiments the present disclosure enables lending institutions to comply with Federal flood insurance monitoring requirements without having to buy a pre-paid, loan-based “life of loan” service. The Servicer is thus enabled to comply with and keep up with flood map revisions without having to supply and continuously update its loan portfolio data to a third party. Further benefits to the Servicer include, but are not limited to: no prepayment of “life of loan” premiums, increased profits, more accurate and efficient life of loan notification procedures, and increased opportunity to reduce closing costs to the buyers. When a lender uses the disclosed business process, the lender is fully equipped to comply with flood zone monitoring requirements without having to buy life of loan service from an FZDC.

In order to utilize the business process, a lender would do the following:

(1) Start ordering “Basic” flood certifications from third party flood vendors rather than “life of loan” flood certifications. The lender is ultimately responsible for complying with flood zone monitoring obligations. The practice of the present inventions enables the lender to comply with such obligations internally, without the requirement of buying life of loan service from an FZDC. Rather, the lender only needs to purchase a “Basic” flood certification that documents a given property's flood hazard status as of the date of the certification in accordance with the NFIRA.

(2) Set up their information systems to interface with the practitioner's web-enabled database, in order to compare their internal list of properties against the properties listed in the practitioner's database (consisting of properties that have been impacted by revisions to flood maps).

(3) Execute specific follow-up activities in the event that a match is made between a property in the lender's internal loan tracking portfolio and an address in the service provider's database. Follow-up activities would include:
(a) If the property has been remapped from “out” of a flood zone to “in” a flood zone, the lender would notify the borrower of the need to obtain flood insurance for the property, or
(b) if the property has been remapped from “in” a flood zone to “out” of a flood zone, the lender would notify the borrower that flood insurance is no longer required for the property.

Although the present inventions have been described in terms of the preferred embodiments, it will be apparent to those of skill in the art that variations may be applied to the systems and methods described and claimed herein and in the steps or in the sequence of steps of the methods described herein without departing from the concept, spirit and scope of the invention. All such variations are contemplated to fall within the scope of the present disclosure and appended claims.

1. A computer-based system for compliance with flood insurance monitoring requirements, comprising a central computer system;
said central computer system comprising storage media for storing at least one database comprising a list of essentially all properties within a selected geographical region that are affected by changes in Flood Insurance Rate Maps or Letters of Map Change;
means for storing and operating computer applications connected to the database storage media; and
a modem connected to the applications means and effective to connect the central computer system to a plurality of remote computers.

2. The system of claim 1, wherein the central computer system is connectable to a plurality of remote computer stations through a web based communication network.

3. The system of claim 1, wherein the central computer system is connectable to a plurality of remote computer stations through a telephonic communication system.

4. The system of claim 1, wherein the central computer system is connectable to a plurality of remote computer stations through a wireless communication system.

5. The system of claim 1, wherein the selected geographical region is the United States of America.

6. The system of claim 1, wherein the selected geographical region is a selected State within the United States of America.

7. The system of claim 1, wherein the selected geographical region is the United States of America and its Territories and Protectorates.

8. The system of claim 1, wherein the central computer system comprises an applications server connected to a database server.

9. The system of claim 1, wherein the central computer system comprises an electronic firewall for restricting access to the database to authorized users.

10. The system of claim 1, wherein the property addresses are standardized postal addresses.

11. The system of claim 1, wherein the changes in Flood Insurance Rate Maps or Letters of Map Change are contained in Federal Emergency Management Agency (FEMA) map updates, official Letters of Map Change (LOMCs), Letters of Map Amendment (LOMA), Letters of Map Revision (LOMR), Conditional Letters of Map Amendment (CLOMA), Conditional Letters of Map Revision (CLOMR), or combinations of any thereof.

12. A computer-implemented method of providing a flood hazard zone determination for selected users on a subscription basis comprising:
obtaining map revision data having relevance to life of loan flood insurance regulations;
processing the data to produce a database including essentially all properties affected by the map revision data in which the properties are identified by property identification information;
storing the database in an electronic storage means; and
providing an electronic interface to a communication system accessible by one or more remote computers, wherein access is provided on a time-based, subscription service for the time period in which the data is supplied.

13. A method of providing a mortgage loan Servicer with Flood Insurance Rate Map (FIRM) information for properties affected by flood map revisions comprising:
obtaining map revision data relevant to Flood Insurance Rate Maps;
compiling a database of essentially all properties in which the properties are affected by the revisions wherein the affected properties are described by property identification information; and
providing selected mortgage Servicers electronic access to the database.

14. The method of claim 13, wherein the map revision data comprises Federal Emergency Management Agency (FEMA) map updates, official Letters of Map Change (LOMCs), Letters of Map Amendment (LOMA), Letters of Map Revision (LOMR), Conditional Letters of Map Amendment (CLOMA), Conditional Letters of Map Revision (CLOMR), or combinations of any thereof.

15. The method of claim 13, wherein the property attributes listed in the database comprise Community Number, FIRM Panel Number, FIRM Panel Suffix, FIRM Effective Date, Special Flood Hazard Areas (SFHA) information, and properties or areas effected by map revision data identified by property identification information.

16. The method of claim 13, wherein the database comprises a listing of affected properties identified by address, city, state, zip code, old zone, new zone, panel, date of revision and community.

17. The method of claim 13, wherein the database comprises a listing of affected geographical areas identified by community, panel, old suffix, new suffix, and effective date of revision.

18. The method of claim 13, wherein access to the database is provided on a subscription basis for a time period covered by the subscription.

19. A method for providing updated Flood Insurance Rate Map information comprising:
obtaining essentially all map revision data relevant to Flood Insurance Rate Maps for the United States of America, and its Territories and Protectorates, wherein the map revision data is obtained from one or more of Federal Emergency Management Agency (FEMA) map updates, official Letters of Map Change (LOMCs), Letters of Map Amendment (LOMA), or Letters of Map Revision (LOMR);
compiling a master list of essentially all properties within the United States of America, its Territories and Protectorates that are affected by the revisions wherein the affected properties are identified by property identification information, comprising address, city, state, zip code, old zone, new zone, panel, date of revision and community, and further wherein property attributes are listed, comprising Community Number, FIRM Panel Number, FIRM Panel Suffix, FIRM Effective Date, and Special Flood Hazard Areas (SFHA) information;
storing the master list in a computer system in which the computer system is connectable to remote computers through a firewall that allows only approved users to connect to the computer; and
providing selected remote computer users electronic access to the master list on a subscription basis.

20. The method of claim 19, further comprising compiling a second master list of map revision data comprising a listing of affected geographical areas identified by community, panel, old suffix, new suffix, and effective date of revision, wherein the second master list is stored on the computer system and is accessible by the approved remote users.

21. The method of claim 19, wherein the subscription is active for a defined time period.
